(19) United States
(12) Patent Application Publication
(10) Pub. No.: US 2005/0261941 A1
(43) Pub. Date: Nov. 24, 2005

(54) Method and system for providing medical decision support

(76) Inventor: Alexander Scarlat, Paoli, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/132,089

(22) Filed: May 18, 2005

Related U.S. Application Data
(60) Provisional application No. 60/573,466, filed on May 21, 2004.

(51) Int. Cl. G06F 17/60

(52) U.S. Cl. 705/3

(57) ABSTRACT

A medical information management system is disclosed comprising at least one patient record repository that includes information identifying treatments and corresponding outcomes for a plurality of different patients. The system further comprises a query generator for generating a message to acquire information concerning a medical condition of a particular patient from the record repository. The query message initiates the acquisition of information from the record repository including data identifying, (i) a group of patients and a number of patients in a group, (ii) those attributes of the patients in the group which are similar to attributes of the particular patient and, (iii) different treatments associated with a medical condition employed by the patients in the group. The system further includes a data analyzer for analyzing the information acquired by the query generator to provide analysis results including (1) mortality of the patients of the group, (2) the length of patient stay in a healthcare facility of the patients of the group and (3) the cost of treatment incurred by the patients of the group.

### CROSS REFERENCE TO RELATED APPLICATIONS

This is a non-provisional application of provisional application Ser. No. 60/573,466 by Alexander Scarlat filed May 21, 2004.

### FIELD OF THE INVENTION

The present invention relates generally to the field of predictive analysis. More particularly, the invention relates to an evidenced based medical decision support system and method that includes statistical analysis of existing medical/healthcare databases to provide a patient and/or caregiver with an objective basis for making decisions between different treatments.

### BACKGROUND OF THE INVENTION

Decision points arise on an ongoing basis between various health care professionals and their patients throughout the course of a patient's care regarding outcomes such as mortality, length of stay and cost. For example, questions may arise, such as, ‘What type of treatment is best suited in terms of proven outcomes for a specific patient and condition? Decision-making is difficult because it requires simultaneous consideration of many specific and general factors. Moreover, answering such questions is more often than not based on art or intuition rather than science. Typically, such decisions are governed by unsystematic observations, outdated and often unproven textbook recipes, common sense and physicians' or patients' relatives and friends personal experience. Accordingly, the outcome of these decision processes may lead to sub-optimal results when compared to rigorous statistical analysis and other possible indices of quality.

The problem with present day clinical workflows, Decision Support Systems (DSS) and Evidence Based Medicine (EBM) is the immense task of identification, analysis, design and implementation. The number of work hours of physicians, nurses, statisticians and IT personnel involved in a single well implemented workflow is prohibitively high.

Existing information systems do not provide adequate decision support for a number of reasons including a lack of feedback from the databases/data stores back to the point of care (i.e., back to the patient and caregiver). As such, the caregiver and the patient are unaware of the vast amount of information already accumulated in the existing databases/data stores as well as of the existing similarities between other patients/conditions and the patient's situation. A further problem with existing information systems is that there is little to no communication between the different components of administrative, clinical and the experimental prediction tools, EBM and DSS. Another problem with existing information systems is that there is typically no automation involved at the level of data analysis (i.e., review and recommendation), thus necessitating the utilization of committees comprised of highly paid physicians, nurses, statisticians and IT specialists for the data analysis and rules/workflow derivation process. An associated problem is that the committees are inefficient in terms of the number of rules/workflows they can come up within a certain amount of time. Thus, the rules/workflows that are developed have little chance of comprehensively covering the wide variety of medical situations that may arise. A still further problem with existing information systems is that the manually derived rules/workflows are not ad hoc, but are instead based on the issues that present some interest to the committee participants and are thus biased. Yet another problem with existing information systems is that committee decisions are typically restricted to their local area and thus are not applicable to other areas. Thus the effort invested in one place and the resulting rules/workflows are not translatable for application to a different geographic location. In addition, the rules and other decision support systems derived by committees comprised of humans—become obsolete within a relatively short time frame because of changes in population demographics, epidemiology, prevention and treatment modalities etc.

### SUMMARY OF THE INVENTION

The present invention addresses the above-noted and other deficiencies of the prior art by providing an evidenced based medical decision support system and associated method that utilizes existing database systems to automatically derive information through ad hoc query and statistical analysis whereby the derived information is fed back to a user in near real time. Advantageously, the information thus retrieved and processed assists a caregiver or patient in deciding between different diagnostic and/or therapeutic modalities based on statistically sound, relevant and unbiased evidence.

Certain exemplary embodiments of the invention provide an evidenced based medical decision support system comprising at least one patient record repository including information identifying treatments and corresponding outcomes for a plurality of different patients; a query generator for generating query messages for: acquiring information concerning at least one medical condition of a particular patient from the at least one repository, identifying a group of patients who share at least one medical attribute with the particular patient, identifying sub-groups of patients from among the identified group of patients, wherein each patient in each of the sub-groups share a common treatment, a data analyzer for analyzing a statistical significance of the patients in each of the identified sub-groups regarding similarity of demographic and clinical attributes of the particular patient and the patients of each of the sub-groups; mortality of the patients of each of the sub-groups, length of patient stay in a healthcare facility of the patients in each of the sub-groups, and cost of treatment of the patients in each of the sub-groups; and providing analysis results back to a user.

In certain embodiments, additional quality indicators may be used, such as, for example, the number of days a patient spent in intensive care, the number of days spent on mechanical ventilation, the number of days with a fever above a certain threshold, and so on.

Further, in certain embodiments, a comparison may also be made of different diagnostic modalities in addition to, or in lieu of, comparing different treatment modalities, as described above. However, it should be understood that at the present time, there are no well accepted structures for classifying symptoms, signs and the benefit/risk ratio for the different diagnostic modalities.

### BRIEF DESCRIPTION OF THE DRAWINGS

A wide array of potential embodiments can be better understood through the following detailed description and the accompanying drawings in which:

FIG. 1 is a block diagram of an exemplary embodiment of an evidenced based medical decision support (EBMDS) system 1500 according to one embodiment;

FIG. 2 is a flow chart of an exemplary embodiment of a method 2000 for managing medical information according to one embodiment; and

FIG. 3 illustrates an exemplary final statistical result 3000 which is presented to a user, according to one embodiment.

### DEFINITIONS

When the following terms are used herein, the accompanying definitions apply:

clinical—patient data regarding existing diseases and conditions (expressed as ICD-9 or ICD-10 codes), procedures (expressed as DRG codes) and treatments (expressed as family of drugs and raw dosing schemes, such as ‘low dosage beta-blockers’)

data analyzer—a module configured to compute (1) the statistical similarity between a particular patient under consideration and each of the identified sub-groups, and (2) differences between the different sub-groups in terms of outcomes, for example.

database—one or more structured sets of persistent data, usually associated with software to update and query the data. A simple database might be a single file containing many records, where the individual records use the same set of fields. A database can comprise a map wherein various identifiers are organized according to various factors, such as identity, physical location, location on a network, function, etc.

demographic—patient data regarding basic descriptive parameters such as age, height, weight, zip code, marital status, race.

executable application—code or machine readable instructions for implementing predetermined functions including those of an operating system, healthcare information system, or other information processing system, for example, in response to a user command or input.

executable procedure—a segment of code (machine readable instruction), sub-routine, or other distinct section of code or portion of an executable application for performing one or more particular processes and may include performing operations on received input parameters (or in response to received input parameters) and provide resulting output parameters.

information—data

medical attribute—a medical characteristic of a patient such as a treatment received by a patient including a major therapeutic intervention undergone by a patient, such as , for example, a coronary artery bypass graft (CABG) or a per-cutaneous transluminal coronary angioplasty (PTCA) or a medically significant characteristic of a patient such as age, gender, weight etc.

modality—a medical diagnostic or therapeutic method.

network—a coupling of two or more information devices for sharing resources (such as printers or CD-ROMs), exchanging files, or allowing electronic communications there-between. Information devices on a network can be physically and/or communicatively coupled via various wire-line or wireless media, such as cables, telephone lines, power lines, optical fibers, radio waves, microwaves, ultra-wideband waves, light beams, etc.

object—as used herein comprises a grouping of data, executable instructions or a combination of both or an executable procedure.

patient—one who is scheduled to, has been admitted to, or has received, health care.

processor—a processor as used herein is a device and/or set of machine-readable instructions for performing tasks. As used herein, a processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor.

query generator—a module configured to generate queries against an existing database(s) to determine similarities between a patient under consideration and a super group of patients.

repository—a memory and/or a database.

similarity—a condition of commonality, or of shared characteristics between two or more items that may be indicated by a statistically computed value computed on an arbitrary scale (1 to 10) denoting the degree of similarity between a particular patient under consideration and each of the identified sub-groups.

server—an information device and/or software that provides some service for other connected information devices via a network.

statistical significance—measured by p value and/or confidence interval (CI)

user—a patient's caregiver.

user interface—a tool and/or device for rendering information to a user and/or requesting information from the user. A user interface includes at least one of textual, graphical, audio, video and animation elements.

Web browser: A software application used to locate and display web pages.

Web Site: A collection of web pages which share a URL, such as, www.ibm.com.

### DETAILED DESCRIPTION

A system according to invention principles de-emphasizes the biased elements in the medical decision process and substitutes them with statistically sound information derived automatically from data already accumulated in existing healthcare information systems (e.g., administrative, financial and clinical IT systems), using predictive analysis. The system assists caregivers and patients alike in making more informed decisions based on sound, relevant and statistically unbiased evidence thus providing a bridge between the data already accumulated in existing healthcare information systems and daily medicine practice.

The system and method automatically derives information that assists a caregiver and patient alike in deciding between different diagnostic and/or therapeutic modalities based on statistically analyzed evidence based medicine. A user is provided with a statistical comparison of two or more therapeutic or diagnostic modalities which inform the end user whether one of the therapeutic or diagnostic modalities under consideration is superior in terms of at least three core parameters: mortality, length of stay and costs. In various embodiments, additional parameters such as, for example, length of stay in a critical care unit, time spent on mechanical ventilation and additional patient satisfaction quality indicators may be incorporated in addition to the three core parameters.

While the system is described herein in the context of a health care setting, such is discussed by way of example. Those skilled in the art will appreciate that the system is applicable to any application that desires to use already accumulated data to make more informed decisions based on statistically sound, relevant and unbiased evidence.

In addition to the features described above, the system provides a number of specific features and advantages over prior art systems including, without limitation: facilitating the practice of evidenced based medicine (EBM) at the point of care or over a network such as the Internet thereby improving the overall quality of care while reducing costs; eliminating human input into the decision making process regarding medical evidence to be employed in EBM thereby significantly reducing costs; significantly increasing the number of evidences, decisions, rules and workflows as compared with human based committees, to significantly increase the likelihood that a large enough group of patients are found that are statistically similar to a patient; eliminating human biases which naturally exist in the list of evidences/decisions/rules/workflows; increasing the quality of decision making; automatically adding a quantitative statistical significance to any finding, evidence, rule or workflow; automatically adding patient experiences presented to the system to the system database to incrementally grow and improve the system's predictive capabilities; implementing the system in a diverse geographic language and/or cultural environment without the need for special configuration or re-design; incorporating different disease and procedure coding systems without the need to redesign, recode or retest; implementing the system on different hardware, operating systems, database platforms, without the need for extensive re-design or re-engineering; increased user compliance with the decision support system (DSS) while simultaneously exhibiting impartiality/objectivity with the data and with the data analysis.

The disclosed elements to be described herein may be comprised of hardware portions (e.g., discrete electronic circuitry), software portions (e.g., computer programming), or any combination thereof. The system according to the invention may be implemented on any suitable computer running an operating system such as UNIX, Windows NT, Windows 2000 or Windows XP. Obviously, as technology changes, other computers and/or operating systems may be preferable in the future. The system as disclosed herein can be implemented using commercially available development tools together with special plug-ins.

Operating Environment

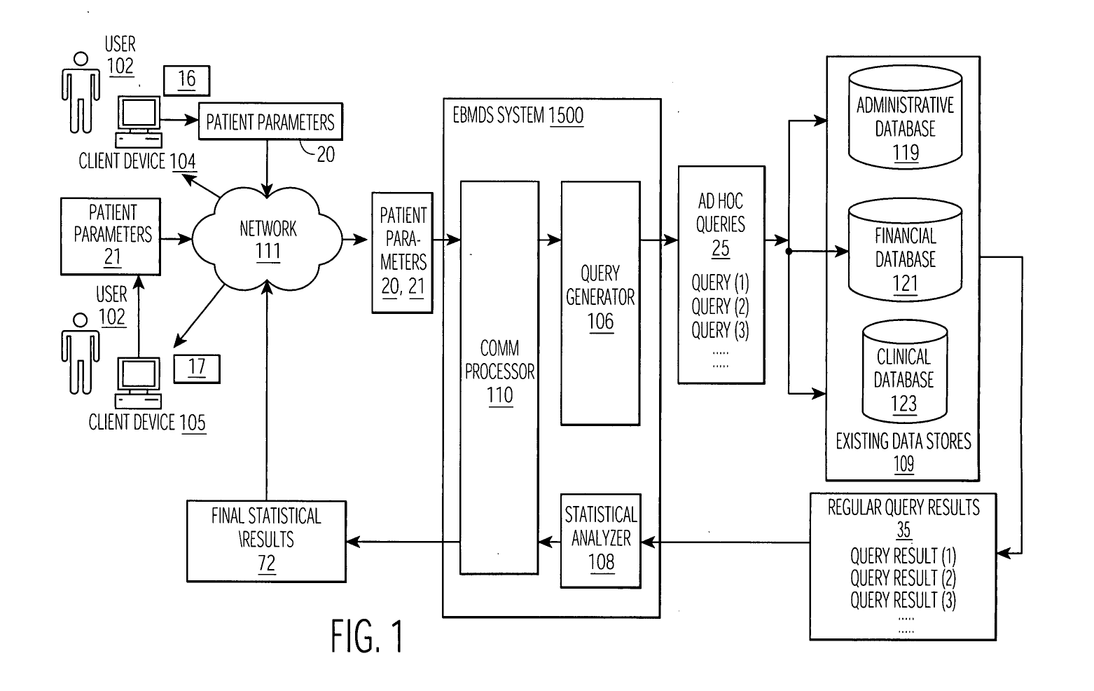

Turning now to FIG. 1, an embodiment of the evidence based medical decision support system (EBMDS) (referred to hereafter as system 1500) is shown. System 1500 includes query generator 106, statistical analyzer 108 and communication processor 110. As shown, system 1500 may be configured to simultaneously receive data inputs from multiple client devices 104, 105, etc., running respective client browsers (e.g. Microsoft Internet Explorer) The client applications 16, 17 are communicably coupled, e.g., through a network 111 such as the Internet to system 1500 via communication processor 110. System 1500 is coupled to an existing data store 109 which comprise a plurality of existing medical/healthcare databases, i.e., an administrative database 119, a financial database 121 and a clinical database 123. Other embodiments may include a different combination of databases depending upon the application.

Mode of Operation

In operation, a user 102 situated at a respective client device 104 generates patient parameter data 20 for a patient (not shown). As used herein, a user 102 defines a caregiver. Patient parameter data 20 is comprised of demographic and clinical data. Demographic data may include, for example, age, gender, weight, height, zip code. Clinical data may include, for example, medical diagnoses, current treatments, current diagnosis and physical status classification. A current patient diagnosis may indicate, for example, that the patient currently suffers from chest pain (ICD code 786.50), angina pectoris (ICD code 413.9), chronic ischemic heart disease (ICD code 414.9) and additionally suffers from diabetes (ICD code 250.02), obesity (ICD code 278.00), and hypertension (ICD code 401.1).

The patient parameter data 20 is transmitted to the query generator 106 over network 111 which can be a wired or wireless network or some combination thereof. In one embodiment, network 111 is the Internet. It is noted that at least a portion of the patient parameter data 20 may be pre-stored in the existing data stores 109, in which case, the user 102 is required to transmit supplementary data along with a suitable patient identifier (e.g., social security number) to access the pre-stored patient parameter data 20 from repository 109. Upon receiving the patient parameter data at the query generator 106, the patient parameter data 20 is parsed to form multiple ad hoc queries 25 (e.g., query (1), query (2), . . . ) which are run against the existing data stores 109 to derive corresponding ad hoc query results 35 (e.g., query (1)→query result (1), query (2)→query result (2), . . . ). The ad hoc query results 35 identify a super group of patients having similar demographic attributes as the patient and further divide the identified super group into a number of sub-groups according to major therapeutic intervention. For example, the patients that comprise one sub-group may have undergone a coronary artery bypass graft (CABG) as one form of major therapeutic intervention, while the patients of a second sub-group may have undergone a per-cutaneous transluminal coronary angioplasty (PTCA) as a second form of major therapeutic intervention. A third group of patients may not have undergone any major therapeutic intervention, referred to herein as ‘medication only’ (i.e., without any surgical or invasive procedure).

Upon receiving the ad hoc query results 35, the statistical analyzer engine 108 makes two determinations. The first determination pertains to statistical similarity, or lack thereof, between the patient and the identified sub-groups with regard to demographic and clinical attributes. Demographic statistical similarity may be performed with regard to attributes such as height, weight, zip code and gender, for example. Clinical statistical similarity may be performed with regard to attributes such as, for example, medical diagnosis, current treatments and physical status classification, for example.

The second determination made by the statistical analyzer engine 108 pertains to whether a diagnostic/therapeutic modality associated with a particular sub-group is found to be superior to the diagnostic/therapeutic modalities associated with the other sub-groups.

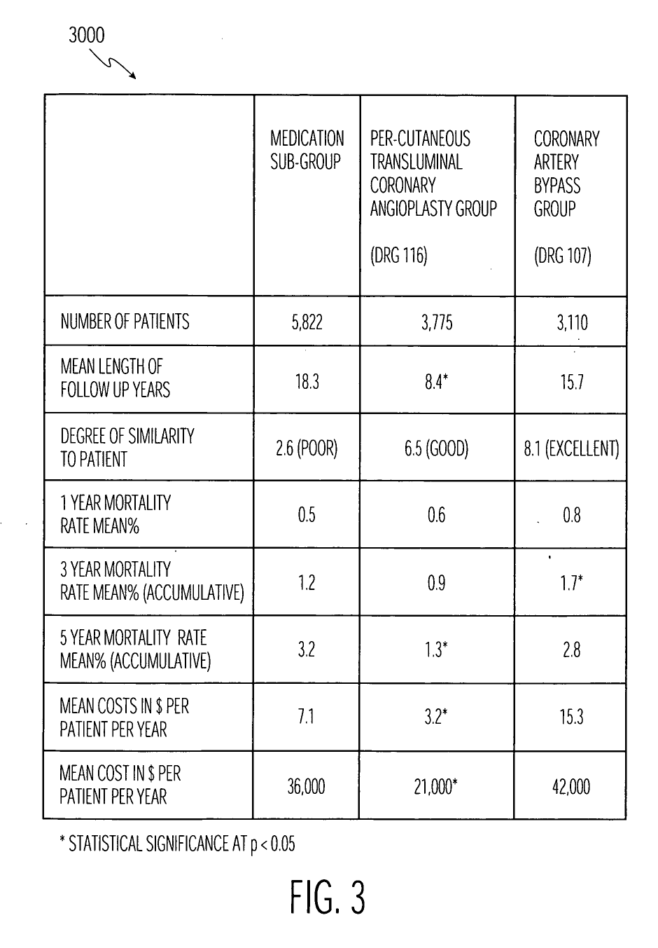

Information indicating the diagnostic/therapeutic modalities associated with the various sub-groups is fed back to the user 102 situated at a client device 104, as a set of final statistical results 72 (as shown in FIG. 1), along with the two determinations described above, to form a closed loop of information, thus providing the user 102 (i.e., caregiver) with a statistically viable means of diagnosing/treating the patient. The set of final statistical results 72 is displayed to the user 102 together with its statistical significance (as shown in FIG. 3 and described below). In addition to determining statistical demographic/clinical significance, the statistical analyzer engine 108 also determines the relevant p value for the combined alpha and beta errors. The p value is a well known and accepted statistical parameter that quantifies the statistical chance of accepting an erroneous hypothesis or rejecting a correct hypothesis when comparing differences between groups. (See, Intuitive Biostatistics (ISBU 0-19-5086074), by Harvey Motulsky, Copyright 1995, Oxford University Press Inc.) For example, accepting that there is a statistical difference between 2 sub-groups when none exists and conversely, accepting that there is no statistical difference between the groups, when in fact one exists. The combined chance for these kinds of statistical errors is defined as p value. Other statistical parameters for measuring similarities as well as differences may be utilized in accordance with principles of the invention.

### EXAMPLE

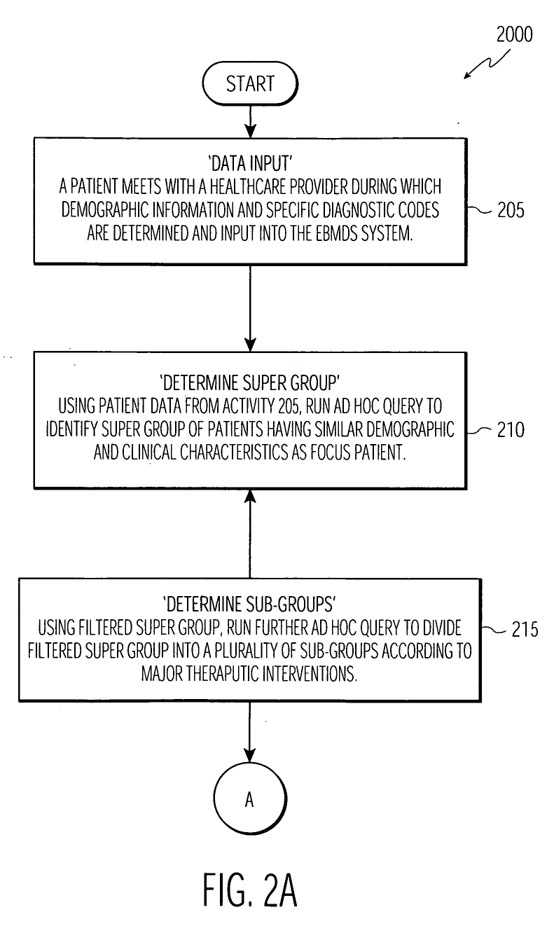

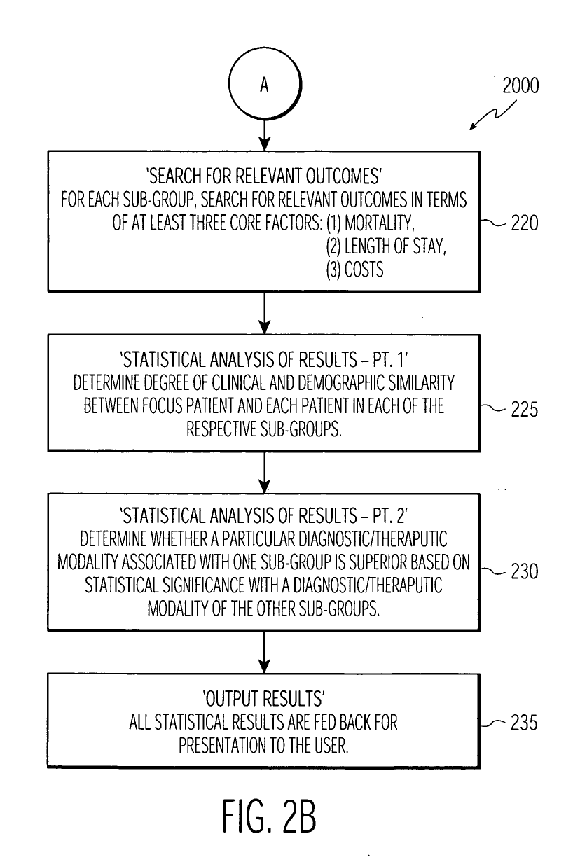

The system and method are now described by way of example in accordance with the flowchart of FIG. 2 which is a top-level flow chart of an exemplary embodiment of a method 2000 for managing medical information.

At activity 205, a patient meets with a healthcare provider or a person with a research interest. During the meeting one of two scenarios occurs. In a first scenario, a significant portion of the required patient information is known to be pre-stored in the existing data stores 109, in which case, supplemental information is provided by the patient at the time of the meeting. In a second scenario, the patient information is not pre-stored in the existing data stores 109 and is instead input into the system 1500 via a respective client device 104 at the time of the meeting. The information collected both from the patient at the time of the meeting and/or retrieved from the existing data stores 109 is comprised of demographic and diagnostic parameters (e.g., specific diagnostic codes). The diagnostic parameters typically comprise specific ICD9 diagnostic codes for ailments such as, for example, obesity, non-insulin dependent diabetes mellitus, hypertension and stable angina pectoris.

At activity 210, using the patient information provided at activity 205, the system 1500 runs a first ad hoc query, query (1), against an existing data store 109 to identify a ‘super group’ of patients that have similar demographic and clinical characteristics as the patient. An exemplary first query is shown as follows:
Query (1)→retrieve a super group of persons similar to the patient with respect to the patient's demographic data, such as patients that are in a similar age group (+/−5 years), same gender, similar financial status, living within a reasonable proximity to the patient (e.g., zip code), having a similar height and weight (+/−10%) and having at least one of the following clinical problems: obesity, hypertension, non-insulin diabetes mellitus and stable angina pectoris and being treated by a combination of beta-blockers, nitrates and ACE inhibitors.

At activity 215, ‘Determine Sub-groups’, using the super group generated at activity 210, system 1500 runs a second ad hoc query, query (2), against the existing data store 109 to divide the ‘super group’ into two or more sub-groups characterized by one of the major therapeutic interventions the patients in the ‘super group’ have undergone. For example, one sub-group may be characterized as a ‘medication only’ sub-group, while another sub-group may be characterized as a ‘per-cutaneous transluminal coronary angioplasty’ sub-group and a third sub-group may be characterized as a ‘coronary artery bypass graft’ sub-group. An example of a second query for dividing the super group is as follows:
Query (2)→divide the super group into multiple sub-groups according to major therapeutic interventions.

A result of executing the second query, query (2), is the creation of sub-groups having a subset of patients from the parent supergroup. For example, the ‘coronary artery bypass’ sub-group may be comprised of 3,110 patients, the ‘per-cutaneous transluminal coronary angioplasty’ sub-group may be comprised of 3,775 patients and the ‘medication only’ sub-group may be comprised of 5,822 patients.

It is desirable that the results provided in the second query result, query result (2), also include, the number of patients in the sub-group, upper and lower limits of age, mean and media age, standard deviations, upper and lower limits of weight/height, mean and median weight and height, for example. These additional parameters are not shown in FIG. 3 for sake of clarity.

At activity 220, for the sub-groups identified at activity 215 above, the query generator 106 searches the existing data stores 109 for relevant outcomes. A relevant outcome is defined herein in terms of at least a minimum of three core factors: mortality, length of stay and costs. For example, a relevant outcome is defined for the sub-groups according to the sub-group's (i) one, three and five year mortality rates, (ii) length of stay in a hospital facility measured in mean, median and upper and lower limits of number of days and (iii) mean, median and upper and lower limits of costs measured in dollar expenditure per month (and per year) per patient, the costs being attributable to diagnostic and therapeutic measures. It should be noted, however, that in other embodiments, other factors may be used in addition to the three core factors, such as, for example, the number of days spent on intravenous antibiotics, the number of days spent in critical care, the number of days the patient is fed by a tube, a compound patient satisfaction factor, the number of days the patient spends on a mechanical ventilator and so on.

At activity 225, the degree of clinical and demographic similarity between the patient and the respective sub-groups identified at activity 215 is quantified. In one embodiment, this may be a consolidated number such as, for example, a number on a scale of 1 to 10 where 1 represents no similarity between the patient and a patient in a sub-group and 10 represents total similarity.

At activity 230, the statistical significance of the difference between the various sub-groups is analyzed. Specifically, a decision is made regarding whether a particular therapeutic and/or diagnostic modality associated with a particular sub-group identified at activity 215 is found to be superior based on its statistical significance as compared with the diagnostic/therapeutic modalities associated with the other sub-groups. For example, determining whether a finding that one sub-group has 3775 patients and a mortality rate of 1.3%, while another sub-group has 3110 patients and a mortality rate of 1.6%, constituting a 0.3% difference is statistically significant. This analysis takes into consideration the difference between the sub-groups together with the number of individuals involved and the inter and intra group variance differences. This analysis may be carried out on more than two sub-groups with a final result indicating that one sub-group is different from the other sub-groups. The simplest final result is for the differences found for the sub-groups to be either significant or non-significant.

At activity 235, The diagnostic/therapeutic modalities are fed back from the system 1500 via communication processor 110 and presented to the user 201 on a user interface such as client device 104, in near real time, in the form of a display image and/or report and/or electronic file. Further, the analysis results may be appended to other medical information for different purposes including, but not limited to, communication, display and storage. In different embodiments, the analysis results may be either automatically appended to other medical data or appended in response to user command. The analysis results may be appended to other medical information for the purpose of ordering a specific diagnostic and/or therapeutic treatment for the patient.

FIG. 3 is an illustration of an exemplary output 3000 generated by system 1500 in the case where three sub-groups are identified at activity 215. The three sub-groups are characterized according to a specific major therapeutic intervention (i.e., ‘medication only’, ‘per-cutaneous tranluminal coronary angioplasty’, ‘coronary artery bypass graft’).

In the exemplary output shown in FIG. 3, the patient may be advised by the user to choose the per-cutaneous tranluminal coronary angioplasty treatment over other treatments due to the fact that it exhibits the best (lowest) comparative mortality rate, i.e., 1.3%, which is statistically significant after 5 years. The ‘per-cutaneous tranluminal coronary angioplasty’ sub-group also exhibits the lowest number of days spent in the hospital, i.e., 3.2, and the lowest overall cost, i.e., $21,000. It is noted that the provided information is statistically significant as measured by a p value lower than 0.05 (combined chance for a statistical error being less than 5%).

The patient can also be made aware of the fact that the ‘per-cutaneous tranluminal coronary angioplasty’ treatment is the newest treatment available from among the three options presented, having 8.4 years of follow up patients. However, it is also observed that the patient's degree of similarity is highest with the ‘coronary artery bypass’ sub-group and as such the patient may not enjoy the same success rate as the patients from the ‘per-cutaneous tranluminal coronary angioplasty’ sub group.

Although this invention has been described with reference to particular embodiments, it should be appreciated that many variations can be resorted to without departing from the spirit and scope of this invention as set forth in the appended claims. The specification and drawings are accordingly to be regarded in an illustrative manner and are not intended to limit the scope of the appended claims.

1. A medical information management system, comprising:
at least one patient record repository including information identifying treatments and corresponding outcomes for a plurality of different patients;
a query generator for generating a message for acquiring information concerning a medical condition of a particular patient from said at least one repository, said query message initiating acquisition of information including data identifying,
a group of patients and a number of patients in said group,
attributes of said patients in said group similar to attributes of said particular patient and
different treatments associated with said medical condition employed by said group of patients; and
a data analyzer for analyzing said acquired information by parameters to provide analysis results including
mortality of said patients of said group,
length of patient stay in a healthcare facility of said patients of said group and
cost of treatment of said patients of said group.

2. A medical decision support system, comprising:
at least one patient record repository including information identifying treatments and corresponding outcomes for a plurality of different patients;
a query generator for generating query messages for:
(i) acquiring demographic and clinical information concerning said particular patient from said at least one repository,
(ii) identifying a group of patients who share at least one medical attribute with said particular patient,
(iii) identifying sub-groups of patients from among said identified group of patients, wherein each patient in a sub-group have received a common treatment,
a data analyzer for:
(i) analyzing a first statistical significance of similarity between said particular patient and individual identified sub-groups, said similarity concerning demographic and clinical attributes of said particular patient and an individual sub-group;
(ii) analyzing a second statistical significance of similarity between at least two identified sub-groups, said similarity concerning:
(a) mortality of said patients of each of said sub-groups,
(b) length of patient stay in a healthcare facility of said patients in said individual sub-group, and
(c) cost of treatment of said patients in said individual sub-group, and
(iii) providing analysis results responsive to said analysis of first and second statistical significance.

3. A system according to claim 2, including
a communication processor for communicating said analyzed data for presentation to a user in at least one of, (a) a display image, b) a report and (c) an electronic file.

4. A system according to claim 2, wherein
said demographic information concerning said particular patient include data identifying age, gender, height, weight, zip code, socio-economic status, marital status, race.

5. A system according to claim 2, wherein
said clinical information concerning said particular patient include diagnostic parameters.

6. A system according to claim 2, wherein
said clinical information concerning said particular patient include diagnostic parameters.

7. A system according to claim 2, wherein
said specific diagnostic parameters comprise ICD9 diagnostic codes.

8. A system according to claim 2, wherein
said similarity concerning said clinical attributes include medical diagnosis, current treatments and physical status classification.

9. A system according to claim 2, wherein
said similarity between said patient and said individual identified sub groups determines if a particular identified sub-group provides a more effective diagnostic/therapeutic modality as compared with all other identified sub-groups.

10. A system according to claim 2, wherein
said major medical attribute shared by said identified group of patients with said particular patient is a major therapeutic intervention.

11. A system according to claim 2, including
a user interface providing one or more display images including a user selectable image element enabling a user to initiate presentation of said analysis results.

12. A system according to claim 2, wherein
said analysis results are appended to other medical information for at least one of, (a) communication, (b) display and (c) storage.

13. A system according to claim 12, wherein
said analysis results are at least one of (a) automatically appended and (b) appended in response to user command.

14. A system according to claim 12, wherein
said analysis results are appended to data representing an order for treatment for a patient.

15. A medical information management system, comprising:
at least one patient record repository including information identifying treatments and corresponding outcomes for a plurality of different patients;
a query generator for generating a message for acquiring information concerning a medical condition of a particular patient from said at least one repository, said query message initiating acquisition of information including data identifying,
a plurality of groups of patients and a number of patients in an individual group,
attributes of said patients in said groups similar to attributes of said particular patient and
different treatments associated with said medical condition employed by said groups of patients; and
a data analyzer for analyzing said acquired information by parameters including
mortality associated with individual groups of said plurality of groups,
length of patient stay in a healthcare facility associated with individual groups of said plurality of groups and
cost of treatment associated with individual groups of said plurality of groups.

16. A system according to claim 15, wherein said data analyzer uses statistical methods to quantify the degree of similarity of patient and each of said sub-groups of patients, said data analyzer uses said determined statistical significance in determining whether differences in parameters between individual groups of said plurality of groups is significant.
